(19) United States
(12) Patent Application Publication
(10) Pub. No.: US 2025/0309273 A1
(43) Pub. Date: Oct. 2, 2025

(54) POSITIVE ELECTRODE PLATE, SECONDARY BATTERY, AND ELECTRONIC DEVICE

(71) Applicant: Ningde Amperex Technology Limited, Ningde City (CN)

(72) Inventor: Meifeng Chen, Ningde City (CN)

(73) Assignee: Ningde Amperex Technology Limited, Ningde City (CN)

(21) Appl. No.: 19/092,131

(22) Filed: Mar. 27, 2025

(30) Foreign Application Priority Data
Mar. 30, 2024 (CN) 202410383357.6

(51) Int. Cl. H01M 4/62; H01M 4/02; H01M 4/131; H01M 4/36; H01M 4/525; H01M 10/0525

(52) U.S. Cl. CPC H01M 4/628; H01M 4/131; H01M 4/366; H01M 4/525; H01M 10/0525; H01M 2004/021; H01M 2004/028

(57) ABSTRACT

A positive electrode plate includes a positive electrode film layer. The positive electrode film layer includes positive active particles, a conductive agent, a binder, and polymer resin particles. A surface coverage A% of the positive active particles satisfies: 55≤A≤65. A drop melting point of the polymer resin particles is 110° C. to 135° C. According to this application, by adding the polymer resin particles of a specified drop melting point into the positive electrode film layer, the polymer resin particles can melt in a high-temperature environment to coat the surface of the positive active particles to form a protection layer, thereby preventing direct contact between an active site on the surface of the positive active particles and an electrolyte solution, suppressing oxidative decomposition of the electrolyte solution, and in turn, improving the thermal safety performance of the battery.

### CROSS REFERENCE TO THE RELATED APPLICATIONS

The present application claims priority to Chinese Patent Application No. 202410383357.6, filed on March. 30, 2024, the disclosure of which is hereby incorporated by reference in its entirety.

### TECHNICAL FIELD

This application relates to the technical field of batteries, and in particular, to a positive electrode plate, a secondary battery, and an electronic device.

### BACKGROUND

Secondary batteries represented by lithium-ion batteries are widely used in digital electronic products, energy storage products, unmanned aerial vehicles, electrical tools, electric vehicles, and the like by virtue of a high energy density, a long cycle life, high safety, fast charging capability, and other characteristics. Currently, the positive active particles in a secondary battery undergo cathode solid electrolyte interface (CEI) film decomposition and irreversible phase transition in a high-temperature and high-pressure environment, and at the same time, release heat and oxygen. The generated oxygen is very active and may decompose an electrolyte solution in contact, thereby further increasing the heat and gas generated by a battery cell and posing safety hazards. Therefore, the thermal safety performance of the battery needs to be improved.

### SUMMARY

This application provides a positive electrode plate, a secondary battery, and an electronic device, and aims to improve the thermal safety performance of the battery by using polymer resin particles in the positive electrode plate.

According to a first aspect, this application provides a positive electrode plate. The positive electrode plate includes a positive electrode film layer. The positive electrode film layer includes positive active particles, a conductive agent, a binder, and polymer resin particles. A surface coverage A % of the positive active particles satisfies: 55≤A≤65. A drop melting point of the polymer resin particles is 110° C. to 135° C.

According to this application, by adding the polymer resin particles of a specified drop melting point into the positive electrode film layer, the polymer resin particles can melt in a high-temperature environment to coat the surface of the positive active particles to form a protection layer, thereby preventing direct contact between an active site on the surface of the positive active particles and an electrolyte solution, suppressing oxidative decomposition of the electrolyte solution, and in turn, improving the thermal safety performance of the battery. In addition, by adjusting the surface coverage of the positive active particles, the impact of the polymer resin particles on electrical performance of the battery is reduced.

In some embodiments, a specific surface area S m²/g of the positive active particles and Dᵥ₅₀ μm of the polymer resin particles satisfy: S≤1/Dᵥ₅₀.

In some embodiments, a specific surface area S m²/g of the positive active particles satisfies: 0.1≤S≤0.3.

In some embodiments, the polymer resin particles satisfy at least one of the following conditions: 1) a heat transfer coefficient of the polymer resin particles is not less than 0.3 W/(m·K); 2) a melt index of the polymer resin particles is not less than 5 g/10 min; or 3) Dᵥ₅₀ μm of the polymer resin particles satisfies: 1≤Dᵥ₅₀≤10, and preferably 2≤Dᵥ₅₀≤5.

In some embodiments, the positive electrode film layer satisfies at least one of the following conditions: 1) the positive active particles include lithium cobalt oxide particles; or, 2) the polymer resin particles include at least one selected from the group consisting of a polyethylene particle, a polypropylene particle, and a polyvinyl alcohol particle.

In some embodiments, the positive electrode film layer satisfies at least one of the following conditions: 1) a mass percentage of the positive active particles in the positive electrode film layer is 94.5% to 98.2%; 2) a mass percentage of the conductive agent in the positive electrode film layer is 0.5% to 2.0%; 3) a mass percentage of the binder in the positive electrode film layer is 0.8% to 2.5%; or, 4) a mass percentage of the polymer resin particles in the positive electrode film layer is 0.5% to 3%, and preferably 0.75% to 1.5%.

In some embodiments, a resistance RΩ of the positive electrode plate baked at T° C. for 10 minutes satisfies: 0.10≤R≤0.20, 25≤T≤85; 0.01T≤R≤0.05T, 100≤T≤135.

In some embodiments, a cohesive force F_{before} N/m of the positive electrode film layer and a cohesive force F_{after} N/m of the positive electrode film layer baked at 135° C. for 30 minutes satisfy: F_{before}≥40, and F_{after}≤0.7F_{before}.

According to a second aspect, this application provides a secondary battery, including a negative electrode plate, a separator, an electrolyte solution, and the positive electrode plate according to any embodiment of the first aspect.

According to a third aspect, this application provides an electronic device, including the secondary battery according to any embodiment of the second aspect.

### DETAILED DESCRIPTION

The embodiments or implementation solutions hereof are described in a progressive manner, and each embodiment focuses on differences from other embodiments.

In the description of this specification, reference to the terms “one embodiment”, “some embodiments”, “illustrative embodiment”, “example”, “specific example”, “some examples”, and the like means that a specific feature, structure, material, or characteristic described with reference to the embodiment or example is included in at least one embodiment or example of this application. In this embodiment, illustrative expressions of such terms do not necessarily refer to the same embodiment or example. In addition, the specific features, structures, materials, or characteristics described may be combined in an appropriate manner in any one or more embodiments or examples.

In addition, the technical terms such as “first” and “second” are used merely for ease of description, but not to indicate or imply relative importance or implicitly specify the number of technical features mentioned. Therefore, the features preceded by “first” or “second” may explicitly or implicitly include at least one of such features. In the description of this application, unless otherwise expressly specified, “a plurality of” means at least two, for example, two, three, or more.

In this application, batteries may include a lithium-ion secondary battery, a lithium-ion primary battery, a lithium-sulfur battery, a sodium-lithium-ion battery, a sodium-ion battery, a magnesium-ion battery, or the like, without being limited herein. The battery may be in the shape of a cylinder, a flat body, a cuboid, or other shapes. The shape of the battery is not limited herein.

As mentioned in the background section above, the positive active particles in a secondary battery undergo CEI film decomposition and irreversible phase transition in a high-temperature and high-pressure environment, and at the same time, release heat and oxygen. The generated oxygen is very active and may decompose an electrolyte solution in contact, thereby further increasing the heat and gas generated by a battery cell and posing safety hazards.

In response to the above problems, the related art improves the thermal safety performance of the battery by using a separator of high heat resistance that prevents thermal runaway caused by direct contact between the positive electrode and the negative electrode due to thermal shrinkage of the separator. However, this method is defective in that the separator of high heat resistance is typically obtained by increasing the thickness of the base film or the coating, and this deteriorates the kinetics of the battery and impairs the energy density at the same time. Another practice to improve the thermal safety performance of the battery in the related art is to add a flame retardant in the electrolyte solution to suppress further oxidative decomposition of the electrolyte solution, but the flame retardant added also deteriorates the kinetics of the battery and significantly reduces the service life of the battery.

Based on this, this application provides a positive electrode plate, a secondary battery, and an electronic device. Polymer resin particles are added in the positive electrode film layer of the positive electrode plate, and can melt in a high-temperature environment and coat the surface of the positive active particles to form a protection layer, thereby improving the thermal safety performance of the battery. The following describes some embodiments of this application in detail.

### Positive Electrode Plate

According to a first aspect, this application provides a positive electrode plate. The positive electrode plate includes a positive electrode film layer. The positive electrode film layer includes positive active particles, a conductive agent, a binder, and polymer resin particles. A surface coverage A % of the positive active particles satisfies: 55≤A≤65. A drop melting point of the polymer resin particles is 110° C. to 135° C.

According to this application, by adding the polymer resin particles of a specified drop melting point into the positive electrode film layer, the polymer resin particles can melt in a high-temperature environment to coat the surface of the positive active particles to form a protection layer, thereby preventing direct contact between an active site on the surface of the positive active particles and an electrolyte solution, suppressing oxidative decomposition of the electrolyte solution, and in turn, improving the thermal safety performance of the battery. In addition, by adjusting the surface coverage of the positive active particles, the impact of the polymer resin particles on electrical performance of the battery is reduced.

Specifically, the drop melting point of the polymer resin particles is 110° C. to 135° C. This is because if the drop melting point of the polymer resin particles is excessively low, the polymer resin particles may melt during the preparation of the positive electrode plate (for example, during drying of the positive electrode plate) and partially cover the surface of the positive active particles, thereby cause the electrical performance of the battery to deteriorate significantly. If the drop melting point of the polymer resin particles is excessively high, the polymer resin may be unable to coat the positive active particles in time before the battery becomes thermal runaway, thereby failing to effectively improve the thermal safety performance of the battery. For example, the drop melting point of the polymer resin particles may be 110° C., 112° C., 115° C., 118° C., 120° C., 122° C., 125° C., 128° C., 130° C., 132° C., 135° C., or a value falling within a range formed by any two thereof. In addition, it is hereby noted that, because the polymer resin particles in this application exhibits a definite drop melting point, the polymer resin is a thermoplastic resin material. The drop melting point of the polymer resin particles is related to the type, molecular weight, and polymerization manner of the polymer. Therefore, the specific type of the polymer resin particles is not particularly limited herein as long as the drop melting point satisfies the above conditions.

Moreover, in order to reduce the impact of the polymer resin particles on the electrical performance of the battery, the surface coverage of the positive active particles is further controlled to be 55% to 65%, so that the battery exhibits good electrical performance in addition to good thermal safety performance. Understandably, the covering on the surface of the positive active particles is a binder, a conductive agent, and polymer resin particles. The surface coverage of the positive active particles may be duly controlled by adjusting the type and mass percentage of each constituent in the positive electrode film layer and the preparation method of the positive electrode film layer. The surface coverage of the positive active particles affects the deintercalation of ions of the positive active particles and the conductive path in the positive electrode film layer. If the surface coverage is excessively low, the polymer resin may be unable to effectively coat the positive active particles after melting, thereby resulting in relatively low thermal safety performance. In addition, the low surface coverage leads to consumption of a relatively large amount of active ions and formation of a solid electrolyte film, thereby impairing the Coulombic efficiency of the battery. If the surface coverage is excessively high, the high surface coverage may affect the deintercalation of ions on the surface of the positive active particles and impair the electrical performance of the battery. In this application, when the surface coverage of the positive active particles is 55% to 65%, the battery is enabled to exhibit good thermal safety performance and electrical performance. For example, A may be 55, 56, 57, 58, 59, 60, 61, 62, 63, 64, 65, or a value falling within a range formed by any two thereof.

Understandably, the drop melting point of the polymer resin particles bears the meaning well-known in the art, and may be tested by using methods and instruments known in the art. For example, the drop melting point may be tested by referring to the method specified in GB8026-87: under specified conditions, vertically immersing a cooled thermometer into a specimen so that the specimen adheres to the thermometer bulb; placing the thermometer with the specimen into a test tube; and heating the specimen in a water bath to melt the specimen until the first drop drips from the thermometer bulb. At this time, the temperature reading of the thermometer is the drop melting point of the specimen.

The surface coverage of the positive active particles bears the meaning well-known in the art, i.e., the degree to which the surface of the positively active particles is covered; and may be tested by using methods and instruments known in the art. For example, the surface coverage may be tested by using the following method: 1) in a (25±3)° C. environment, removing an electrode plate coated with a positive electrode film layer from a finished battery cell, and wiping off, with dust-free paper, the electrolyte solution that remains on the surface of the electrode plate; 2) observing the detached electrode plate by using a backscatter diffraction mode in a scanning electron microscope (SEM); 3) processing the image captured by the SEM, calculating the percentage of the area in which the grayscale value is less than or equal to 100, and recording the percentage as the surface coverage of the positive active particles.

In some embodiments, the specific surface area S m²/g of the positive active particles and Dᵥ₅₀ μm of the polymer resin particles satisfy: S≤1/Dᵥ₅₀.

In some of the above embodiments, the relationship between the specific surface area S m²/g of the positive active particles and the Dᵥ₅₀ μm of the polymer resin particles is further defined. Understandably, the larger the specific surface area of the positive active particles, the more molten polymer resin is required to completely coat the positive active particles. When the mass percentage of each constituent in the positive electrode film layer is constant, the smaller the Dᵥ₅₀ μm of the polymer resin particles, the more favorably the positive active particles can be coated uniformly, and the larger the area that can be covered. Therefore, when the specific surface area S m²/g of the positive active particles and the Dᵥ₅₀ μm of the polymer resin particles satisfy S≤1/Dᵥ₅₀, the contact between the electrolyte solution and the positive active particles is more effectively blocked, thereby further improving the thermal safety performance of the battery.

In some embodiments, the specific surface area S m²/g of the positive active particles satisfies: 0.1≤S≤0.3.

In some of the above embodiments, a relatively high specific surface area is conducive to the deintercalation of active ions by the positive active particles. In addition, reducing the specific surface area appropriately facilitates the polymer resin particles to completely coat the positive active particles. Therefore, a suitable specific surface area further improves the thermal safety performance and electrical performance of the battery. When the specific surface area S m²/g of the positive active particles satisfies 0.1≤S≤0.3, the battery can exhibit good thermal safety performance and good electrical performance in a more balanced manner. For example, S may be 0.1, 0.12, 0.15, 0.18, 0.2, 0.22, 0.25, 0.28, 0.3, or a value falling within a range formed by any two thereof.

The specific surface area of the positive active particles bears the meaning well-known in the art, and may be tested by a method known in the art. For example, the specific surface area may be tested by using a gas adsorption method. A specific test method performed with reference to the standard GB/T19587-2017 is as follows: using a positive active particle as a specimen, and immersing the specimen tube in −196° C. liquid nitrogen; measuring the adsorption amount of nitrogen on the solid surface under different relative pressures that range from 0.05 to 0.30; and determining a monolayer adsorption amount of the specimen based on the BET multilayer adsorption theory and formula, and calculating the specific surface area of the solid.

In some embodiments, the heat transfer coefficient of the polymer resin particles is not less than 0.3 W/(m·K). Understandably, the higher the heat transfer coefficient of the polymer resin particles, the more conducive the polymer resin particles are to the transfer of heat in the positive electrode film layer. Therefore, in a high-temperature environment, the polymer resin particles can respond to the temperature quickly, and coat the positive active particles more quickly to form a protection layer, thereby further improving the thermal safety performance of the battery. For example, the heat transfer coefficient of the polymer resin particles may be 0.3 W/(m·K), 0.35 W/(m·K), 0.4 W/(m·K), 0.45 W/(m·K), 0.5 W/(m·K), 0.55 W/(m·K), 0.6 W/(m·K), 0.65 W/(m·K), 0.7 W/(m·K), 0.75 W/(m·K), 0.8 W/(m·K), or a value falling within a range formed by any two thereof.

The heat transfer coefficient of the polymer resin particles bears the meaning well-known in the art, and may be tested by a method known in the art. For example, the test is performed with reference to the standard ASTM 5470: using a heat flow meter method, placing a specimen of a specified thickness between two flat plates, passing a constant unidirectional heat flow in a direction perpendicular to the flat plates, and then placing a calibrated sensor between the flat plate and the specimen to measure the heat flow that passes through the specimen; measuring, when the temperature of the hot plate and the cold plate becomes stable, the thickness of the specimen, the temperatures of the upper and lower surfaces, and the heat flow that passes through the specimen, and then calculating the heat transfer coefficient of the specimen based on the Fourier's law.

In some embodiments, the melt index of the polymer resin particles is not less than 5 g/10 min. Understandably, the higher the melt index of the polymer resin particles, the higher the fluidity of the polymer resin particles after melting, thereby facilitating the polymer resin to form a uniform and complete protection layer on the surface of the positive active particles, and in turn, further improving the thermal safety performance of the battery. For example, the melt index of the polymer resin particles may be 5 g/10 min, 5.5 g/10 min, 6 g/10 min, 6.5 g/10 min, 7 g/10 min, 7.5 g/10 min, 8 g/10 min, 8.5 g/10 min, 9 g/10 min, or a value falling within a range formed by any two thereof.

The melt index of the polymer resin particles bears the meaning well-known in the art, and may be tested by a method known in the art. For example, the melt index may be tested with reference to the standard ASTM D1238-04: first, loading the polymer resin particles into a barrel, and melting the particles into a plastic fluid, and then measuring, through a standard die (typically with a diameter of 2.1 mm), the mass (g) of the plastic fluid that flows out within 10 minutes. The measured value is the melt index.

In some embodiments, the Dᵥ₅₀ μm of the polymer resin particles satisfies: 1≤D,ᵥ₅₀≤10, and preferably 2≤Dᵥ₅₀≤5.

In some of the above embodiments, generally, the smaller the Dᵥ₅₀ μm of the polymer resin particles, the easier it is for the polymer resin particles to coat the positive active particles over a large area at high temperature, thereby further improving the thermal safety performance of the battery. In addition, because the surface of the positive active particles is covered with a composition of the conductive agent, the binder, and the polymer resin particles, and because the conductivity of the polymer resin particles is generally low, the particle size of the polymer resin particles also affects the conductivity between the positive active particles, thereby affecting the electrical performance of the battery. Therefore, when the Dᵥ₅₀ μm of the polymer resin particles satisfies 1≤Dᵥ₅₀≤10, the battery can exhibit good thermal safety performance and good electrical performance in a more balanced manner. For example, Dᵥ₅₀ may be 1, 1.5, 2, 2.5, 3, 3.5, 4, 4.5, 5, 5.5, 6, 6.5, 7, 7.5, 8, 8.5, 9, 9.5, 10, or a value falling within a range formed by any two thereof. Further preferably, 2≤Dᵥ₅₀<5.

The Dᵥ₅₀ μm of the polymer resin particles bears the meaning well-known in the art, that is, a particle diameter corresponding to a 50% cumulative volume distribution percent in a volume-based particle size distribution curve of the sample particles, and may be measured by a known method. For example, the Dᵥ₅₀ μm is obtained by measuring the particle size distribution with a laser diffraction particle size analyzer (Malvern Mastersizer 3000) based on particle size distribution laser diffractometry with reference to GB/T19077-2016.

In some embodiments, the positive active particles may include the positive active particles well-known in the art for use in a secondary battery. As an example, the positive active particles may include at least one of the following materials: olivine-structured lithium-containing phosphate salt or a modified compound thereof, or lithium transition metal oxide or a modified compound thereof. However, this application is not limited to such materials, and other conventional materials usable as positive active particles of a battery may be used instead. One of such types of positive active particles may be used alone, or at least two types of such positive active particles may be used in combination. Examples of the lithium transition metal oxide may include, but without being limited to, at least one of lithium cobalt oxide (such as LiCoO₂), lithium nickel oxide (such as LiNiO₂), lithium manganese oxide (such as LiMnO₂ and LiMn₂O₄), lithium nickel cobalt oxide, lithium manganese cobalt oxide, lithium nickel manganese oxide, lithium nickel cobalt manganese oxide (such as LiNi_{1/3}Co_{1/3}Mn_{1/3}O₂ (briefly referred to as NCM333), LiNi_{0.5}Co_{0.2}Mn_{0.3}O₂ (briefly referred to as NCM523), LiNi_{0.5}Co_{0.25}Mn_{0.25}O₂ (briefly referred to as NCM211), LiNi_{0.6}Co_{0.2}Mn_{0.2}O₂ (briefly referred to as NCM622), LiNi_{0.8}Co_{0.1}Mn_{0.1}O₂ (briefly referred to as NCM811), lithium nickel cobalt aluminum oxide (such as LiNi_{0.85}Co_{0.15}Al_{0.05}O₂), or a modified compound thereof. Examples of the olivine-structured lithium-containing phosphate may include, but without being limited to, at least one of lithium iron phosphate (such as LiFePO₄ (briefly referred to as LFP)), a composite of lithium iron phosphate and carbon, lithium manganese phosphate (such as LiMnPO₄), a composite of lithium manganese phosphate and carbon, lithium manganese iron phosphate, or a composite of lithium manganese iron phosphate and carbon.

In some embodiments, the positive active particles include lithium cobalt oxide particles. Used as positive active particles, the lithium cobalt oxide particles exhibit good electrical performance and stability, but a large number of active sites exist on the surface of the lithium cobalt oxide particles. Therefore, when the positive active particles such as the lithium cobalt oxide particles are in use, the thermal safety performance of the battery is generally low. However, in this application, the polymer resin particles in use can coat the positive active particles at high temperature to form a protection layer, thereby improving the thermal safety performance of the battery significantly.

In some embodiments, the polymer resin particles may include, but are not limited to, at least one selected from the group consisting of a polyethylene particle, a polypropylene particle, and a polyvinyl alcohol particle. The above-mentioned polymer resin particles are commonly used in the art. The drop melting point, melt index, and heat transfer coefficient of such particles are easily adjustable. The polymer resin particles are cost-effective and conducive to reducing cost. In addition, the conductivity of the above-mentioned polymer resin particles is low, thereby further improving the thermal safety performance of the battery. It is hereby noted that the above-mentioned polymer resin particles are merely exemplary, and the polymer resin particles are not limited to the above-mentioned types. A person skilled in the art may select other polymer resin particles known in the art according to actual needs.

In some embodiments, the binder may include at least one of polyvinylidene difluoride (PVDF), polytetrafluoroethylene (PTFE), poly(vinylidene fluoride-co-tetrafluoroethylene-co-propylene), poly (vinylidene fluoride-co-hexafluoropropylene-co-tetrafluoroethylene), poly(tetrafluoroethylene-co-hexafluoropropylene), or fluorinated acrylate resin.

In some embodiments, the conductive agent may include at least one of superconductive carbon, acetylene black, carbon black, Ketjen black, carbon dots, carbon nanotubes, graphene, or carbon nanofibers.

Understandably, the above-mentioned binders and the conductive agents are exemplary, and a person skilled in the art may make selection according to actual needs.

In some embodiments, the mass percentage of the positive active particles in the positive electrode film layer is 94.5% to 98.2%. In this case, the battery achieves a higher energy density and exhibits higher thermal safety performance. For example, the mass percentage of the positive active particles in the positive electrode film layer may be 94.5%, 95%, 95.5%, 96%, 96.5%, 97%, 97.5%, 98%, 98.2%, or a value falling within a range formed by any two thereof.

In some embodiments, the mass percentage of the conductive agent in the positive electrode film layer is 0.5% to 2.0%. In this case, the positive electrode plate possesses a lower resistance, so that the battery exhibits higher electrical performance. For example, the mass percentage of the conductive agent in the positive electrode film layer may be 0.5%, 0.8%, 1%, 1.2%, 1.5%, 1.8%, 2%, or a value falling within a range formed by any two thereof.

In some embodiments, the mass percentage of the binder in the positive electrode film layer is 0.8% to 2.5%. In this case, the positive electrode film layer possesses a higher cohesive force, thereby further improving the cycle stability of the battery. For example, the mass percentage of the binder in the positive electrode film layer may be 0.8%, 1%, 1.2%, 1.5%, 1.8%, 2%, 2.2%, 2.5%, or a value falling within a range formed by any two thereof.

In some embodiments, the mass percentage of the polymer resin particles in the positive electrode film layer is 0.5% to 3%. Therefore, in a high-temperature environment, the polymer resin particles can coat the positive active particles more efficiently to form a protection layer, thereby improving the thermal safety performance of the battery while imposing little impact on the electrical performance of the battery. For example, the mass percentage of the polymer resin particles in the positive electrode film layer may be 0.5%, 0.8%, 1%, 1.2%, 1.5%, 1.8%, 2%, 2.2%, 2.5%, 2.8%, 3%, or a value falling within a range formed by any two thereof. Preferably, the mass percentage is 0.75% to 1.5%.

In some embodiments, the positive electrode plate includes a positive current collector. The positive current collector includes two surfaces opposite to each other in the thickness direction of the current collector. The positive electrode film layer is disposed on either or both of the two opposite surfaces of the positive current collector.

In some embodiments, the positive current collector may be a metal foil or a composite current collector. For example, the metal foil may be aluminum foil. The composite current collector may include a polymer material substrate and a metal layer formed on at least one surface of the polymer material substrate. The composite current collector may be formed by overlaying the polymer material substrate with a metal material (for example, aluminum, aluminum alloy, nickel, nickel alloy, titanium, titanium alloy, silver, and silver alloy). The polymer material substrate may be, for example, polypropylene (PP), polyethylene terephthalate (PET), polybutylene terephthalate (PBT), polystyrene (PS), or polyethylene (PE).

In some embodiments, the positive electrode plate may be prepared by the following method: dispersing the above-mentioned constituents of the positive electrode plate such as the positive active particles, the conductive agent, the binder, and the polymer resin particles into a solvent (such as N-methyl-pyrrolidone) to form a positive electrode slurry, applying the positive electrode slurry onto the positive current collector, and performing steps such as oven-drying and cold pressing to obtain a positive electrode plate.

In some embodiments, the resistance R Ω of the positive electrode plate baked at T° C. for 10 minutes satisfies: 0.10≤R≤0.20, 25≤T≤85; 0.01T≤R≤0.05T, 100≤T≤135.

In some of the above embodiments, the resistance of the positive electrode plate baked at 25°° C. to 85° C. for 10 minutes is 0.1 to 0.2 Ω, indicating that the resistance of the positive electrode plate is low at normal operating temperature, thereby improving the electrical performance of the battery. In the case of 100≤T≤135, the resistance R Ω of the positive electrode plate satisfies: 0.01T≤R≤0.05T, indicating that the resistance of the positive electrode plate begins to increase significantly at 100° C., thereby improving the thermal safety performance of the battery. Understandably, although 100° C. does not reach the drop melting point of the polymer resin particles in the positive electrode film layer, the polymer resin begins to expand at relatively high temperature, thereby affecting the conductive path of the positive electrode film layer and increasing the resistance. In addition, when the temperature rises to the melting point of the polymer resin particles, the resistance is even higher, indicating that the coating degree of the molten polymer resin on the positive active particles is higher, thereby further improving the thermal safety performance of the battery. In other words, when the positive electrode plate meets the above conditions, the battery exhibits higher thermal safety performance and electrical performance.

The resistance R Ω of the positive electrode plate baked at T° C. for 10 minutes bears the meaning well-known in the art, and may be tested by a person skilled in the art according to known methods and instruments, for example, by using the following method:
1) Charging a battery at a constant current of 0.55C until the voltage reaches a nominal voltage indicating a full charge state, and then charging the battery at a constant voltage of the nominal voltage until the current reaches a cut-off current of 0.025C so that the lithium-ion battery reaches a full charge state.
2) Disassembling the battery to obtain a positive electrode plate.
3) Placing the positive electrode plate obtained in step 2) in a T°° C. oven for 10 minutes, and then cooling the positive electrode plate to room temperature, and sealing the positive electrode plate and moving it to a resistance test site.
4) Using a BER1200 sheet resistance meter to test the resistance of the positive electrode plate obtained in step 3); spacing out adjacent test points at intervals of 2 mm to 3 mm; testing the resistance at 15 or more different points; averaging out the resistance values at all test points, and recording the average value as the resistance of the oven-dried positive electrode plate. The test parameters are: the area of a press head is 153.94 mm², the pressure is 3.5 t, and the holding time is 50 s.

In some embodiments, a cohesive force F_{before} N/m of the positive electrode film layer and a cohesive force F_{after} N/m of the positive electrode film layer baked at 135° C. for 30 minutes satisfy: F_{before}≥40, and F_{after}≤0.7F_{before}.

In some of the above embodiments, the resistance of the positive electrode film layer before baking is at least 40 N/m. The relatively high cohesive force can ensure the stability of the positive electrode film layer when the positive electrode plate is used at normal temperature. In other words, when the volume expansion of the polymer resin particles is relatively small, the complete conductive path can still be ensured, thereby improving the electrical performance of the battery. After being baked at 135° C., the polymer resin particles in the positive electrode film layer melt to coat the positive active particles. Due to the low adhesiveness of the polymer resin, the coating reduces the cohesive force of the positive electrode film layer. The smaller the cohesive force after baking, the higher the coating degree for the positive active particles in the positive electrode film layer, that is, the higher the thermal safety performance of the battery. When F_{after}≤0.7F_{before}, the battery exhibits higher thermal safety performance.

The cohesive force of the positive electrode film layer bears the meaning well-known in the art, and may be tested by a person skilled in the art by using known methods and instruments, for example, by using the following method: testing the cohesive force of the positive electrode film layer by a 90° angle method by using a GoTech tensile machine commonly used in the lithium battery industry. A specific test method is as follows: making a part, coated with an active layer, of the positive electrode plate of a finished battery into strips, and bonding a part of the positive electrode plate to a steel sheet from one end of the electrode plate along the length direction by using double-sided tape; and then fixing the steel sheet to a corresponding position of the GoTech tensile machine, and pulling up the adhesive tape with one end bonded to the steel sheet; putting the adhesive tape into a clamp directly or by means of a connector so as to clamp the adhesive tape; starting the test with the GoTech tensile machine when the tensile force at the gripping jaw is greater than 0 kgf and less than 0.02 kgf; and recording the average of the finally measured tensile force values as the cohesive force of the positive electrode film layer.

### Secondary Battery

According to a second aspect, this application provides a secondary battery, including a negative electrode plate, a separator, an electrolyte solution, and the positive electrode plate according to any embodiment of the first aspect.

According to this application, the secondary battery includes the positive electrode plate disclosed in any one of the embodiments of the first aspect, and therefore, exhibits the beneficial effects of the first aspect.

### Positive Electrode Plate

The positive electrode plate may be selected according to any embodiment of the first aspect.

### Negative Electrode Plate

The negative electrode plate includes a negative current collector and a negative electrode film layer disposed on at least one surface of the negative current collector. The negative electrode film layer includes a negative active material.

As an example, the negative current collector includes two surfaces opposite to each other in a thickness direction of the negative current collector. The negative electrode film layer is disposed on either or both of the two opposite surfaces of the negative current collector.

In some embodiments, the negative current collector may be a metal foil or a composite current collector. For example, the metal foil may be copper foil. The composite current collector may include a polymer material substrate and a metal layer formed on at least one surface of the polymer material substrate. The composite current collector may be formed by overlaying the polymer material substrate with a metal material (for example, copper, copper alloy, nickel, nickel alloy, titanium, titanium alloy, silver, and silver alloy). The polymer material substrate may be, for example, polypropylene (PP), polyethylene terephthalate (PET), polybutylene terephthalate (PBT), polystyrene (PS), or polyethylene (PE).

In some embodiments, the negative active material may be a negative active material well-known in the art for use in a battery. As an example, the negative active material may include at least one of the following materials: artificial graphite, natural graphite, soft carbon, hard carbon, silicon-based material, tin-based material, lithium titanium oxide, and the like. The silicon-based material may be at least one selected from elemental silicon, a silicon-oxygen compound, a silicon-carbon composite, a silicon-nitrogen composite, and a silicon alloy. The tin-based material may be at least one selected from elemental tin, a tin-oxygen compound, or a tin alloy. However, this application is not limited to such materials, and other conventional materials usable as a negative active material of a battery may be used instead. One of the negative active materials may be used alone, or at least two thereof may be used in combination.

In some embodiments, the negative electrode film layer further optionally includes a binder. The binder may be at least one selected from styrene-butadiene rubber (SBR), polyacrylic acid (PAA), polyacrylic acid sodium (PAAS), polyacrylamide (PAM), polyvinyl alcohol (PVA), sodium alginate (SA), polymethyl acrylic acid (PMAA), and carboxymethyl chitosan (CMCS).

In some embodiments, the negative electrode film layer further optionally includes a conductive agent. The conductive agent may be at least one selected from superconductive carbon, acetylene black, carbon black, Ketjen black, carbon dots, carbon nanotubes, graphene, or carbon nanofibers.

In some embodiments, the negative electrode film layer further optionally includes other agents, such as a thickener (for example, sodium carboxymethyl cellulose (CMC-Na)).

In some embodiments, the negative electrode plate may be prepared according to the following method: dispersing the above-mentioned constituents of the negative electrode plate such as the negative active material, the conductive agent, the binder, and any other constituents in a solvent (such as deionized water) to form a negative electrode slurry, applying the negative electrode slurry onto a negative current collector, and performing steps such as oven-drying and cold pressing to obtain a negative electrode plate.

### Separator

The separator is disposed between the positive electrode plate and the negative electrode plate, and primarily serves to prevent a short circuit between the positive electrode plate and the negative electrode plate while allowing passage of active ions. The type of the separator is not particularly limited herein, and may be any well-known porous separator that is highly stable both chemically and mechanically.

In some embodiments, the material of the separator may be one or more selected from, but is not limited to, glass fibers, non-woven fabric, polyethylene, polypropylene, or polyvinylidene fluoride. Optionally, the material of the separator may include polyethylene and/or polypropylene. The separator may be a single-layer film or a multilayer composite film. When the separator is a multilayer composite film, different layers may be made of the same material or different materials. In some embodiments, the separator may be coated with a ceramic coating or a metal oxide coating.

### Electrolyte Solution

The electrolyte solution serves to conduct active ions between the positive electrode plate and the negative electrode plate. The electrolyte solution applicable to the secondary battery in this application may be an electrolyte solution known in the prior art.

In some embodiments, the electrolyte solution may include an organic solvent, an electrolyte salt, and optionally an additive. The types of the organic solvent, the lithium salt, and the additive are not particularly limited, and may be selected according to actual needs.

In some embodiments, the secondary battery is a lithium-ion battery, and the electrolyte salt may include a lithium salt. As an example, the lithium salt includes, but is not limited to, at least one of lithium hexafluorophosphate (LiPF₆), lithium tetrafluoroborate (LiBF₄), lithium perchlorate (LiCIO₄), lithium bis(fluorosulfonyl)imide (LiFSI), lithium bis(trifluoromethanesulfonyl)imide (LiTFSI), lithium trifluoromethanesulfonate (LiTFS), lithium difluoro(oxalato)borate (LiDFOB), lithium bis(oxalato)borate (LiBOB), lithium difluorophosphate (LiPO₂F₂), lithium difluoro(bisoxalato) phosphate (LiDFOP), or lithium tetrafluoro(oxalato)phosphate (LiTFOP). Of the above lithium salts, one may be used alone, or two or more may be used simultaneously.

In some embodiments, the secondary battery is a sodium-ion battery, and the electrolyte salt may include a sodium salt. As an example, the sodium salt may be at least one selected from NaPF₆, NaClO₄, NaBCl₄, NaSO₃CF₃, or Na(CH₃)C₆H₄SO₃.

In some embodiments, as an example, the organic solvent includes but is not limited to at least one of ethylene carbonate (EC), propylene carbonate (PC), ethyl methyl carbonate (EMC), diethyl carbonate (DEC), dimethyl carbonate (DMC), dipropyl carbonate (DPC), methyl propyl carbonate (MPC), ethylene propyl carbonate (EPC), butylene carbonate (BC), fluoroethylene carbonate (FEC), methyl formate (MF), methyl acetate (MA), ethyl acetate (EA), propyl acetate (PA), methyl propionate (MP), ethyl propionate (EP), propyl propionate (PP), methyl butyrate (MB), ethyl butyrate (EB), 1,4-butyrolactone (GBL), sulfolane (SF), methyl sulfonyl methane (MSM), ethyl methyl sulfone (EMS), or (ethylsulfonyl)ethane (ESE). Of the foregoing organic solvents, one may be used alone, or two or more may be used simultaneously. Optionally, two or more of the foregoing organic solvents are used simultaneously.

In some embodiments, the additive may include a negative film-forming additive or a positive film-forming additive. The additive may further include an additive capable of improving specified performance of the battery, for example, an additive for improving overcharge performance of the battery, or an additive for improving high- or low-temperature performance of the battery.

As an example, such additives include, but are not limited to, at least one of fluoroethylene carbonate (FEC), vinylene carbonate (VC), vinyl ethylene carbonate (VEC), ethylene sulfate (DTD), propylene sulfate, ethylene sulfite(ES), 1,3-propane sultone (PS), 1,3-propene sultone (PST), sulfonate cyclic quaternary ammonium salt, succinic anhydride, succinonitrile (SN), adiponitrile (ADN), tris(trimethylsilane)phosphate (TMSP), or tris(trimethylsilane)borate (TMSB).

The electrolyte solution may be prepared by a conventional method in this field. For example, the electrolyte solution may be obtained by mixing well an organic solvent, an electrolyte salt, and an optional additive. The order of adding the constituents is not particularly limited. For example, the electrolyte salt and the optional additive may be added into the organic solvent and mixed well to obtain the electrolyte solution; or, the electrolyte salt may be added into the organic solvent, and then the optional additive is added into the organic solvent and mixed well to obtain the electrolyte solution.

### Electronic Device

According to a third aspect, this application provides an electronic device, including the secondary battery disclosed in any embodiment of the second aspect.

According to this application, the electronic device includes the secondary battery disclosed in any embodiment of the second aspect, and therefore, the electronic device brings the beneficial effects of the second aspect.

The electronic device is not particularly limited in this application, and may be any electronic device known in the prior art. In some embodiments, the types of the electronic device may include, but are not limited to, a laptop computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household storage battery, lithium-ion capacitor, or the like.

The following describes some embodiments of this application. The embodiments described below are illustrative, and are merely intended to construe this application but not to limit this application. Unless techniques or conditions are otherwise expressly specified in an embodiment hereof, the techniques or conditions described in the literature in this field or in an instruction manual of the product are applicable in the embodiment. A reagent or instrument used herein without specifying a manufacturer is a conventional product that is commercially available in the market.

### Testing the Thermal Abuse Pass Rate

A to-be-tested lithium-ion battery is charged at a constant current of 0.5C until the voltage reaches the nominal voltage (that is, the full charge voltage), and then charged at the nominal voltage (full charge voltage) until the current drops to 0.025C (cut-off current) indicating that the lithium-ion battery reaches a full charge state. The appearance of the lithium-ion battery before the test is recorded. The battery is placed in a 25° C. oven, and the oven is heated to 130° C. at a heating rate of 5° C./min. The temperature is kept constant for 60 minutes. Subsequently, the temperature is reduced to 50° C., and the test is stopped. The status of the lithium-ion batteries during the test is observed in groups, each group containing 10 lithium-ion batteries. It is determined that the lithium-ion battery passes the test if the battery does not catch fire or explode.

### Testing the C-Rate Performance of the Battery

A lithium-ion battery is left to stand for 5 minutes at a temperature of 25° C., and then charged at a constant current of 0.7C until the voltage reaches the nominal voltage (that is, full charge voltage), and then charged at a constant voltage of the nominal voltage (full charge voltage) until the current drops to 0.05C (cut-off current). Subsequently, the battery is left to stand for 5 minutes, and then discharged at a constant current of 0.2C until a voltage of 3.0 V, and the 0.2C discharge capacity is recorded. Afterward, the battery is left to stand for 5 minutes, and the above charging process is repeated, and then the battery is discharged at a constant current of 2C, and the 2C discharge capacity is recorded. C-rate performance=(2C discharge capacity/0.2C discharge capacity)×100%.

### Embodiment 1

Preparing an electrolyte solution Ethylene carbonate (EC) and dimethyl carbonate (DMC) are mixed well at a volume ratio of 1:1 in a glovebox filled with argon (in which the moisture content is less than 10 ppm and the oxygen content is less than 1 ppm). LiPF6 and 5 vol % fluoroethylene carbonate (FEC) are added slowly into the mixed solution. The mixed solution is stirred well to obtain an electrolyte solution.

### Preparing a Positive Electrode Plate

Positive active particles, Super P (SP) as a conductive agent, carbon nanotubes (CNTs) as another conductive agent, polyvinylidene difluoride (PVDF) as a binder, and polymer resin particles are mixed at a mass ratio of 96.6:0.8:0.3:1.3:1, where the positive active particles are lithium cobalt oxide (LCO) with a specific surface area of 0.3 m²/g, and the polymer resin particles are polyethylene particles with a Dᵥ₅₀ μm of 1 μm, a drop melting point of 120° C., a heat transfer coefficient of 0.4 W/(m·K), and a melt index of 8 g/10 min. N-methyl-pyrrolidone (NMP) is added as a solvent into the mixture to form a slurry in which the solid content is 75%. The mixture is stirred with a vacuum mixer until the system becomes a homogeneous positive electrode slurry. The positive electrode slurry is applied evenly onto one surface of a 13 μm-thick positive current collector aluminum foil, and dried at 85° C. to obtain a positive electrode plate coated with a positive electrode film layer on a single side. Subsequently, the above steps are repeated on the other surface of the positive electrode plate to obtain a positive electrode plate coated with the positive electrode film layer on both sides. After being coated, the foil is cold-pressed and cut to obtain a positive electrode plate. The surface coverage A % of the positive active particles in the positive electrode film layer is 59%.

### Preparing a Negative Electrode Plate

Graphite as a negative active material, CNT and Super P as a conductive agent, and sodium polyacrylate (PAA-Na) as a binder are mixed at a mass ratio of 90:1.5:0.5:8, and then deionized water is added as a solvent to form a negative electrode slurry in which the solid content is 54%. The mixture is stirred well with a vacuum mixer until the system becomes a homogeneous negative electrode slurry. The negative electrode slurry is applied evenly onto one surface of a 6 μm-thick copper foil, and dried at 85° C. to obtain a negative electrode coated with the negative active material on a single side. Subsequently, the above steps are repeated on the other surface of the negative electrode to obtain a negative electrode plate coated with the negative active material on both sides. After being coated, the foil is cold-pressed and cut to obtain a negative electrode plate.

### Preparing a Separator

The separator is a 5 μm-thick polyethylene substrate (PE). A 2 μm-thick alumina ceramic layer is applied on both sides of the separator. Finally, polyvinylidene difluoride (PVDF) is applied at a concentration of 2.5 mg/cm² on both sides of the separator coated with the ceramic layer, and then the separator is dried.

Preparing a Lithium-Ion Battery

The above-prepared separator, positive electrode plate, separator, and negative electrode plate are stacked in sequence in such a way that the separator is located between the positive electrode plate and the negative electrode plate to serve a function of separation, and then the stacked structure is wound to obtain an electrode assembly. Tabs are welded to the electrode assembly, and then the electrode assembly is loaded into an aluminum laminated film packaging shell, and dehydrated in an 85° C. vacuum oven for 12 hours. The above-prepared electrolyte solution is injected into the packaging shell. Steps such as vacuum sealing, standing, chemical formation, shaping, and capacity test are performed to obtain a lithium-ion battery.

The lithium-ion battery is subjected to a thermal abuse test and a C-rate performance test. The resistances R₄₀ and R₁₃₅ of the positive electrode plate baked at 40° C. and 135° C. for 10 minutes separately are measured. The cohesive force F_{before} of the positive electrode film layer and the cohesive force F_{after} of the positive electrode film layer baked at 135° C. for 30 minutes are tested. The results are shown in Table 1.

### Embodiments 1 to 19 and Comparative Embodiments 2 to 5

Substantially identical to Embodiment 1 except some parameters in the positive electrode film layer, as detailed in Table 1.

The lithium-ion battery is subjected to a thermal abuse test and a C-rate performance test. The resistances R₄₀ and R₁₃₅ of the positive electrode plate baked at 40° C. and 135° C. for 10 minutes separately are measured. The cohesive force F_{before} of the positive electrode film layer and the cohesive force F_{after} of the positive electrode film layer baked at 135° C. for 30 minutes are tested. The results are shown in Table 1.

### Comparative Embodiment 1

Substantially identical to Embodiment 1 except that no polymer resin particles are added into the positive electrode film layer, and an equal amount of positive active particles are used instead.

The lithium-ion battery is subjected to a thermal abuse test and a C-rate performance test. The resistances R₄₀ and R₁₃₅ of the positive electrode plate baked at 40° C. and 135° C. for 10 minutes separately are measured. The cohesive force F_{before} of the positive electrode film layer and the cohesive force F_{after} of the positive electrode film layer baked at 135° C. for 30 minutes are tested. The results are shown in Table 1.

TABLE 1

| | Positive electrode film layer | | | | | | | | |
|---|---|---|---|---|---|---|---|---|---|
| | Positive active particles | | | Polymer resin particles | | | | | |
| | | Specific | | | | Drop | Heat | Melt | |
| | Surface | surface | Mass | | | melting | transfer | index | Mass |
| | coverage | area S | percentage | | Dᵥ₅₀ | point | coefficient | (g/10 | percentage |
| | A (%) | (m²/g) | (%) | Type | (μm) | (° C.) | (W/(m · K)) | min) | (%) |
| Embodiment | 59 | 0.30 | 96.6 | Polyethylene | 1.0 | 120 | 0.4 | 8 | 1.0 |
| 1 | | | | | | | | | |
| Embodiment | 61 | 0.25 | 96.6 | Polyethylene | 3.0 | 120 | 0.4 | 8 | 1.0 |
| 2 | | | | | | | | | |
| Embodiment | 57 | 0.20 | 96.6 | Polyethylene | 5.0 | 120 | 0.4 | 8 | 1.0 |
| 3 | | | | | | | | | |
| Embodiment | 62 | 0.15 | 96.6 | Polyethylene | 6.5 | 120 | 0.4 | 8 | 1.0 |
| 4 | | | | | | | | | |
| Embodiment | 63 | 0.10 | 96.6 | Polyethylene | 10.0 | 120 | 0.4 | 8 | 1.0 |
| 5 | | | | | | | | | |
| Embodiment | 58 | 0.20 | 96.6 | Polyethylene | 0.5 | 120 | 0.4 | 8 | 1.0 |
| 6 | | | | | | | | | |
| Embodiment | 60 | 0.20 | 96.6 | Polyethylene | 12.0 | 120 | 0.4 | 8 | 1.0 |
| 7 | | | | | | | | | |
| Embodiment | 61 | 0.40 | 96.6 | Polyethylene | 3.0 | 120 | 0.4 | 8 | 1.0 |
| 8 | | | | | | | | | |
| Embodiment | 60 | 0.20 | 96.1 | Polyvinyl alcohol | 3.0 | 130 | 0.3 | 7 | 1.5 |
| 9 | | | | | | | | | |
| Embodiment | 61 | 0.20 | 96.1 | Polypropylene | 3.0 | 135 | 0.3 | 6 | 1.5 |
| 10 | | | | | | | | | |
| Embodiment | 60 | 0.20 | 97.1 | Polyethylene | 3.0 | 120 | 0.4 | 8 | 0.5 |
| 11 | | | | | | | | | |
| Embodiment | 59 | 0.20 | 96.1 | Polyethylene | 3.0 | 120 | 0.4 | 8 | 1.5 |
| 12 | | | | | | | | | |
| Embodiment | 63 | 0.20 | 95.6 | Polyethylene | 3.0 | 120 | 0.4 | 8 | 2.0 |
| 13 | | | | | | | | | |
| Embodiment | 63 | 0.20 | 95.1 | Polyethylene | 3.0 | 120 | 0.4 | 8 | 2.5 |
| 14 | | | | | | | | | |
| Embodiment | 61 | 0.20 | 94.6 | Polyethylene | 3.0 | 120 | 0.4 | 8 | 3.0 |
| 15 | | | | | | | | | |
| Embodiment | 55 | 0.20 | 97.2 | Polyethylene | 3.0 | 120 | 0.4 | 8 | 0.4 |
| 16 | | | | | | | | | |
| Embodiment | 58 | 0.20 | 94.5 | Polyethylene | 3.0 | 120 | 0.4 | 8 | 3.1 |
| 17 | | | | | | | | | |
| Embodiment | 60 | 0.20 | 96.8 | Polyethylene | 3.0 | 110 | 0.5 | 10 | 0.8 |
| 18 | | | | | | | | | |
| Embodiment | 58 | 0.20 | 96.8 | Polyethylene | 3.0 | 115 | 0.6 | 9 | 0.8 |
| 19 | | | | | | | | | |
| Comparative | 61 | 0.20 | 97.6 | \ | \ | \ | \ | \ | 0 |
| Embodiment | | | | | | | | | |
| 1 | | | | | | | | | |
| Comparative | 62 | 0.20 | 96.6 | Polyethylene | 3.0 | 138 | 0.5 | 4 | 1 |
| Embodiment | | | | | | | | | |
| 2 | | | | | | | | | |
| Comparative | 48 | 0.60 | 97.5 | Polyethylene | 10.0 | 120 | 0.4 | 8 | 0.1 |
| Embodiment | | | | | | | | | |
| 3 | | | | | | | | | |
| Comparative | 69 | 0.05 | 94.6 | Polyethylene | 0.5 | 120 | 0.4 | 8 | 3 |
| Embodiment | | | | | | | | | |
| 4 | | | | | | | | | |
| Comparative | 60 | 0.20 | 96.6 | Polyethylene | 3.0 | 100 | 0.5 | 10 | 1.0 |
| Embodiment | | | | | | | | | |
| 5 | | | | | | | | | |

| | | | | | | | C-rate |
|---|---|---|---|---|---|---|---|
| | | | | | | Thermal | performance |
| | | | | | | abuse | tested at |
| | | R₄₀ | R₁₃₅ | F_{before} | F_{after} | pass | 2 C/0.2 C |
| | 1/Dᵥ₅₀ | (Ω) | (Ω) | (N/m) | (N/m) | rate | (%) |
| Embodiment | 1.00 | 0.17 | 2.80 | 52.0 | 35.6 | 10/10 | 93.3 |
| 1 | | | | | | | |
| Embodiment | 0.33 | 0.14 | 2.10 | 52.6 | 35.9 | 10/10 | 93.7 |
| 2 | | | | | | | |
| Embodiment | 0.20 | 0.14 | 2.00 | 52.3 | 36.1 | 10/10 | 93.8 |
| 3 | | | | | | | |
| Embodiment | 0.15 | 0.13 | 1.70 | 52.9 | 36.3 | 9/10 | 94.1 |
| 4 | | | | | | | |
| Embodiment | 0.10 | 0.13 | 1.30 | 52.8 | 36.8 | 8/10 | 94.2 |
| 5 | | | | | | | |
| Embodiment | 2.00 | 0.19 | 3.30 | 51.8 | 34.7 | 10/10 | 89.8 |
| 6 | | | | | | | |
| Embodiment | 0.08 | 0.12 | 0.90 | 52.1 | 37.0 | 6/10 | 94.6 |
| 7 | | | | | | | |
| Embodiment | 0.33 | 0.11 | 0.85 | 51.3 | 36.8 | 5/10 | 95.0 |
| 8 | | | | | | | |
| Embodiment | 0.33 | 0.16 | 1.90 | 52.4 | 35.8 | 10/10 | 94.7 |
| 9 | | | | | | | |
| Embodiment | 0.33 | 0.15 | 1.70 | 52.6 | 35.9 | 10/10 | 95.3 |
| 10 | | | | | | | |
| Embodiment | 0.33 | 0.12 | 1.10 | 53.0 | 36.5 | 10/10 | 94.3 |
| 11 | | | | | | | |
| Embodiment | 0.33 | 0.14 | 2.50 | 52.3 | 35.2 | 10/10 | 93.4 |
| 12 | | | | | | | |
| Embodiment | 0.33 | 0.17 | 2.80 | 52.0 | 34.9 | 10/10 | 92.8 |
| 13 | | | | | | | |
| Embodiment | 0.33 | 0.18 | 3.70 | 51.9 | 33.5 | 10/10 | 92.5 |
| 14 | | | | | | | |
| Embodiment | 0.33 | 0.20 | 6.50 | 51.6 | 32.1 | 10/10 | 92.3 |
| 15 | | | | | | | |
| Embodiment | 0.33 | 0.15 | 0.80 | 52.5 | 43.0 | 5/10 | 94.6 |
| 16 | | | | | | | |
| Embodiment | 0.33 | 0.25 | 7.50 | 52.4 | 30.2 | 10/10 | 88.3 |
| 17 | | | | | | | |
| Embodiment | 0.33 | 0.18 | 2.30 | 51.8 | 33.2 | 10/10 | 93.5 |
| 18 | | | | | | | |
| Embodiment | 0.33 | 0.16 | 2.10 | 52.0 | 34.8 | 10/10 | 93.6 |
| 19 | | | | | | | |
| Comparative | \ | 0.11 | 0.13 | 52.7 | 51.9 | 0/10 | 95.7 |
| Embodiment | | | | | | | |
| 1 | | | | | | | |
| Comparative | 0.33 | 0.13 | 1.30 | 52.8 | 46.5 | 2/10 | 94.5 |
| Embodiment | | | | | | | |
| 2 | | | | | | | |
| Comparative | 0.10 | 0.10 | 0.35 | 46.8 | 41.3 | 3/10 | 96.3 |
| Embodiment | | | | | | | |
| 3 | | | | | | | |
| Comparative | 2.00 | 0.30 | 8.90 | 55.0 | 32.8 | 10/10 | 73.8 |
| Embodiment | | | | | | | |
| 4 | | | | | | | |
| Comparative | 0.33 | 0.48 | 10.6 | 38.7 | 29.5 | 10/10 | 70.1 |
| Embodiment | | | | | | | |
| 5 | | | | | | | |

As shown in Table 1, the lithium-ion battery obtained in each embodiment exhibits good thermal safety performance and electrical performance in a more balanced manner. In Comparative Embodiment 1, no polymer resin particles are added, and therefore, the thermal safety performance is the lowest. In Comparative Embodiment 2, the drop melting point of the polymer resin is excessively high, and the polymer resin is unable to quickly coat the positive active particles, and therefore, the thermal safety performance is inferior. In Comparative Embodiment 3, although the polymer resin particles are added, the surface coverage of the positive active particles is relatively low, and the polymer resin particles are unable to effectively coat the positive active particles at high temperature, and the number of surface active sites is relatively large, and therefore, the thermal safety performance is also inferior. In Comparative Embodiment 4, the surface coverage of the positive active particles is excessively high, and therefore, the electrical performance of the battery is impaired although the thermal safety performance is good. In Comparative Embodiment 5, with an excessively low drop melting point, the polymer resin particles may melt during the preparation of the electrode plate, thereby resulting in poor electrical performance.

As shown in Embodiments 1 to 8, the specific surface area of the positive active particles and the particle diameter of the polymer resin particles affect the thermal safety performance and electrical performance of the battery to some extent. When S≤1/Dᵥ₅₀, the battery exhibits higher thermal safety performance. In addition, when 0.1≤S≤0.3 and 1≤Dᵥ₅₀≤10, the battery can exhibit good thermal safety performance and electrical performance in a more balanced manner.

As can be seen from Embodiments 1, 9, and 10, different types of polymer resin particles in use can make the battery exhibit good thermal safety performance and electrical performance.

As can be seen from Embodiment 1 and Embodiments 11 to 17, the content of the polymer resin particles affects the thermal safety performance and electrical performance of the battery to some extent. When the mass percentage of the polymer resin particles in the positive electrode film layer is 0.5% to 3%, the battery can exhibit good thermal safety performance and electrical performance in a more balanced manner.

As can be seen from Embodiments 2, 9, 10, 18, and 19, the polymer resin particles with a drop melting point of 110° C. to 135° C. can improve the thermal safety performance of the battery effectively.

Finally, it is hereby noted that the foregoing embodiments are merely intended for describing the technical solutions of this application, but not for limiting this application. Although this application is described in detail with reference to the foregoing embodiments, a person of ordinary skill in the art understands that modifications may still be made to the technical solutions described in the foregoing embodiments, or equivalent replacements may still be made to some or all technical features thereof, without departing from the scope of the technical solutions of the embodiments of this application.

What is claimed is:

1. A positive electrode plate comprising a positive electrode film layer; wherein the positive electrode film layer comprises positive active particles, a conductive agent, a binder, and polymer resin particles; a surface coverage of the positive active particles is A %, 55≤A≤65; and a drop melting point of the polymer resin particles is 110° C. to 135° C.

2. The positive electrode plate according to claim 1, wherein a specific surface area of the positive active particles is S m²/g, and S≤1/Dᵥ₅₀; wherein Dᵥ₅₀ μm is a particle diameter corresponding to a 50% cumulative volume distribution percent in a volume-based particle size distribution curve of the polymer resin particles.

3. The positive electrode plate according to claim 1, a specific surface area of the positive active particles is S m²/g, wherein 0.1≤S≤0.3.

4. The positive electrode plate according to claim 1, wherein the polymer resin particles satisfy at least one of the following conditions:
1) a heat transfer coefficient of the polymer resin particles is not less than 0.3 W/(m·K);
2) a melt index of the polymer resin particles is not less than 5 g/10 min; or
3) 1≤Dᵥ₅₀≤10, Dᵥ₅₀ μm is a particle diameter corresponding to a 50% cumulative volume distribution percent in a volume-based particle size distribution curve of the polymer resin particles.

5. The positive electrode plate according to claim 4, wherein 2≤Dᵥ₅₀≤5.

6. The positive electrode plate according to claim 1, wherein the positive electrode film layer satisfies at least one of the following conditions:
1) the positive active particles comprise lithium cobalt oxide particles; or
2) the polymer resin particles comprise at least one selected from the group consisting of a polyethylene particle, a polypropylene particle, and a polyvinyl alcohol particle.

7. The positive electrode plate according to claim 1, wherein the positive electrode film layer satisfies at least one of the following conditions:
1) a mass percentage of the positive active particles in the positive electrode film layer is 94.5% to 98.2%;
2) a mass percentage of the conductive agent in the positive electrode film layer is 0.5% to 2.0%;
3) a mass percentage of the binder in the positive electrode film layer is 0.8% to 2.5%; or
4) a mass percentage of the polymer resin particles in the positive electrode film layer is 0.5% to 3%.

8. The positive electrode plate according to claim 7, wherein the mass percentage of the polymer resin particles in the positive electrode film layer is 0.75% to 1.5%.

9. The positive electrode plate according to claim 1, wherein a resistance of the positive electrode plate baked at T° C. for 10 minutes is R Ω, 0.10≤R≤0.20, 25≤T≤85; 0.01T≤R≤0.05T, 100≤T≤135.

10. The positive electrode plate according to claim 1, wherein a cohesive force of the positive electrode film layer before baked is F_{before} N/m and a cohesive force of the positive electrode film layer baked at 135° C. for 30 minutes is F_{after} N/m, F_{before}≥40, and F_{after}≤0.7F_{before}.

11. A secondary battery, the secondary battery comprising a negative electrode plate, a separator, an electrolyte solution, and a positive electrode plate; the positive electrode plate comprising a positive electrode film layer; wherein the positive electrode film layer comprises positive active particles, a conductive agent, a binder, and polymer resin particles; a surface coverage of the positive active particles is A%, 55≤A≤65; and a drop melting point of the polymer resin particles is 110° C. to 135° C.

12. The secondary battery according to claim 11, wherein a specific surface area of the positive active particles is S m²/g, and S≤1/Dᵥ₅₀; wherein Dᵥ₅₀ μm is a particle diameter corresponding to a 50% cumulative volume distribution percent in a volume-based particle size distribution curve of the polymer resin particles.

13. The secondary battery according to claim 11, a specific surface area of the positive active particles is S m²/g, wherein 0.1≤S≤0.3.

14. The secondary battery according to claim 11, wherein the polymer resin particles satisfy at least one of the following conditions:
1) a heat transfer coefficient of the polymer resin particles is not less than 0.3 W/(m·K);
2) a melt index of the polymer resin particles is not less than 5 g/10 min; or
3) 1≤Dᵥ₅₀≤10, Dᵥ₅₀ μm is a particle diameter corresponding to a 50% cumulative volume distribution percent in a volume-based particle size distribution curve of the polymer resin particles.

15. The secondary battery according to claim 14, wherein 2≤Dᵥ₅₀≤5.

16. The secondary battery according to claim 11, wherein the polymer resin particles comprise at least one selected from the group consisting of a polyethylene particle, a polypropylene particle, and a polyvinyl alcohol particle; and
the mass percentage of the polymer resin particles in the positive electrode film layer is 0.5% to 3%.

17. The secondary battery according to claim 16, wherein the mass percentage of the polymer resin particles in the positive electrode film layer is 0.75% to 1.5%.

18. The secondary battery according to claim 11, wherein a resistance of the positive electrode plate baked at T° C. for 10 minutes is R Ω, 0.10≤R≤0.20, 25≤T≤85; 0.01T≤R≤0.05T, 100≤T≤135.

19. The secondary battery according to claim 11, wherein a cohesive force of the positive electrode film layer before baked is F_{before} N/m and a cohesive force of the positive electrode film layer baked at 135° C. for 30 minutes is F_{after} N/m, F_{before}≥40, and F_{after}≤0.7F_{before}.

20. An electronic device, wherein the electronic device comprises the secondary battery according to claim 11.
